(19) United States
(12) Patent Application Publication
(10) Pub. No.: US 2008/0205878 A1
(43) Pub. Date: Aug. 28, 2008

(54) Digital camera

(75) Inventor: Masao Owashi, Yokohama-shi (JP)

Correspondence Address: STAAS & HALSEY LLP, SUITE 700, 1201 NEW YORK AVENUE, N.W., WASHINGTON, DC, 20005, US

(73) Assignee: NIKON CORPORATION, Tokyo (JP)

(21) Appl. No.: 12/010,644

(22) Filed: Jan. 28, 2008

(30) Foreign Application Priority Data
Jan. 30, 2007 (JP) JP 2007-019192

(51) Int. Cl. G03B 19/00; B08B 17/04

(52) U.S. Cl. 396/429; 359/509

(57) ABSTRACT

A digital camera includes: a camera body provided with an inlet port and an outlet port for a spray gas, the camera body defining a space in a photographic light path; a first passage formed in the camera body to communicate the inlet port and the outlet port, the first passage being provided with a restricted section; and a communication unit that communicates the restricted section of the first passage with the space in the photographic light path in the camera body. When the dust is floating in the space in the photographic light path and the spray gas flows through the first passage, the dust floating in the space is led to the restricted section.

### INCORPORATION BY REFERENCE

The disclosure of the following priority application is herein incorporated by reference:

Japanese Patent Application No. 2007-19192 (filed Jan. 30, 2007).

### BACKGROUND OF THE INVENTION

1. Field of the Invention

The present invention relates to a digital camera capable of excluding dust floating on a photographic light path.

2. Description of Related Art

In a camera of which a photographic lens is interchangeable, such as a single-lens reflex digital camera, there is a possibility that dust will come into the inside of the camera. When the lens is mounted, dust will be generated by a sliding part of a quick return mirror and a shutter mechanism when they are driven and such dust will adhere to a light-receiving surface of an image sensor or a surface of an optical member located in a short distance from the light-receiving surface of the image sensor to deteriorate the quality of a photographic image.

To cope with this problem, a camera that is configured to remove dust that adheres to the surface of the image sensor is known (see, for example, Japanese Laid-open Patent Application No. 2003-319218). The conventional camera is provided on the rear side thereof with a supply port and a discharge port through which air is supplied from outside of the camera toward a front surface of the image sensor to remove the dust that adheres to the front surface of the image sensor and discharge the removed dust to the outside of the camera together with the air.

### SUMMARY OF THE INVENTION

However, discharging dust with air supplied to the front surface of the image sensor as in the above-mentioned conventional camera does not make it possible to discharge dust that is present in a region where air flow does not occur, so that the dust can not be removed from within the camera sufficiently.

The digital camera according to a first aspect of the present invention includes a camera body provided with an inlet port and an outlet port for a spray gas, the camera body defining a space in a photographic light path; a first passage formed in the camera body to communicate the inlet port and the outlet port, the first passage being provided with a restricted section; and a communication unit that communicates the restricted section of the first passage with the space in the photographic light path in the camera body. When the spray gas flows through the first passage, dust floating in the space in the photographic light path is led to the restricted section by flow of the spray gas.

According to a second aspect, the digital camera according to the first aspect of the present invention further includes: an image sensor having a front surface on which an image of a photographic subject is incident via the photographic light path; an optical member arranged near the front surface of the image sensor; and a shutter unit arranged in front of the optical member in the photographic light path. The space in the photographic light path is a space between the optical member and the shutter unit.

According to a third aspect, the digital camera according to the first aspect, further includes: a second passage branching from the first passage upstream of the restricted section. The second passage is configured to lead the spray gas that flows in through the inlet port for the spray gas toward a surface of an object to which dust adheres in the photographic light path.

According to a fourth aspect, the digital camera according to the third aspect further includes: a flow rate distribution varying unit that varies flow rate distribution between a flow rate of the spray gas that passes through the second passage and a flow rate of the spray gas that does not pass through the second passage and flows toward the outlet port.

According to a fifth aspect, in the digital camera according to the first aspect, the communication unit includes a suction unit provided facing the space in the photographic light path; and a passage guiding a flow from the suction unit to the restricted section.

According to a sixth aspect, in the digital camera according to the fifth aspect, the suction unit includes a plurality of suction ports, and the passage guiding a flow from the suction unit to the restricted section includes a confluent passage that unites flows from the plurality of suction ports and guides the united flow to the restricted section.

According to a seventh aspect, in the digital camera according to the sixth aspect, the plurality of suction ports has each a rectangular opening and are arranged adjacent to each other.

According to an eighth aspect, the digital camera according to the seventh aspect further includes: an image sensor having a front surface on which an image of a photographic subject is incident via the photographic light path; an optical member arranged near the front surface of the image sensor; and a shutter unit arranged in front of the optical member. The plurality of suction ports are arranged so as to cover a predetermined area of a plane parallel to a bottom surface of a space between the optical member and the shutter unit.

According to a ninth aspect, in the digital camera according to the sixth aspect, each of the plurality of suction ports is in the form of a funnel.

According to a tenth aspect, in the digital camera according to the sixth aspect, the plurality of suction ports are arranged separate one from another.

According to an eleventh aspect, in the digital camera according to the third aspect, the second passage is provided with a plurality of spray nozzles that sprays the spray gas.

According to a twelfth aspect, in the digital camera according to the fourth aspect, the flow rate distribution unit includes a valve mechanism.

According to a thirteenth aspect, the digital camera according to the fourth aspect further includes: a drive unit that drives the flow rate distribution unit.

According to a fourteenth aspect, the digital camera according to the first aspect further includes: a protective member capable of sealing the inlet port for the spray gas.

According to a fifteenth aspect, in the digital camera according to the fourteenth aspect, the protective member is provided through a hinge on a side of the camera body where the inlet port is provided.

According to a sixteenth aspect, in the digital camera according to the fourteenth aspect, the protective member has a concave section on its inner side, a counterbore section capable of engaging with the concave section of the protective member is proved around the inlet port for the spray gas, and the protective member is rotatable to a close position at which the inlet port for the spray gas is sealed.

According to an eighteenth aspect, in the digital camera according to the first aspect, the inlet port for the spray gas is provided with a tapered section having an increased diameter outward, and the tapered section is capable of receiving a spray gas injection device that injects the spray gas into the first passage.

According to an eighteenth aspect, the digital camera includes: a camera body provided with an inlet port and an outlet port for a spray gas, the camera body defining a space including a photographic light path therein; an image sensor provided in the camera body which receives an image of a photographic subject through the photographic light path; an optical member provided in front of the imaging sensor in the photographic light path; a shutter unit arranged in front of the optical member in the photographic light path; and a dust removing unit provided in the camera body that removes dust mixed in or generated in the camera body. The dust removing unit includes a first passage formed in the camera body to communicate the inlet port and the outlet port, the first passage being provided with a restricted section having a reduced cross-section; a second passage branching from the first passage upstream of the restricted section, configured to lead the spray gas that flows in through the inlet port for the spray gas toward a surface of an object to which dust adheres in the photographic light path; a flow rate distribution varying unit that is provided on a position where the second passage branches from the first passage and is adapted to vary flow rate distribution between a flow rate of the spray gas that passes through the second passage and a flow rate of the spray gas that does not pass through the second passage and flows to the outlet port; and a communication unit that communicates the restricted section of the first passage with the space in the photographic light path in the camera body. When the spray gas injected from the inlet port flows through the first passage and the second passage, the dust on the surface of the object comes off from the surface of the object due to flow of the spray gas from the second passage and dust floating in the space in the photographic light path containing the dust coming off from the surface of the object is led to the restricted section of the first passage through the communication unit due to a negative pressure generated in the restricted section and is discharged from the outlet port due to flow of the spray gas that passes through the first passage toward the outlet port via the restricted section.

According to the present invention, dust on the photographic light path of a digital camera can be sufficiently removed.

### BRIEF DESCRIPTION OF THE DRAWINGS

FIG. 1 is a cross-sectional view schematically showing a construction in whole of a digital camera according to a first embodiment of the present invention;

FIG. 2 is a perspective view showing a construction of a dust removal unit in the distal camera according to the first embodiment;

FIG. 3 is a perspective view showing a major portion of the dust removal unit shown in FIG. 2;

FIG. 4 is a perspective view showing a construction of a side portion of a camera body of the digital camera according to the first embodiment;

FIG. 5 is a cross-sectional view of the camera body in FIG. 4 along the V-V line;

FIG. 6 is a schematic diagram illustrating a dust removing operation of the digital camera according to the first embodiment;

FIG. 7 is a perspective view showing a construction of the dust removal unit of the digital camera according to the second embodiment; and

FIG. 8 is a perspective view showing a construction of a modification of the dust removal unit of the digital camera shown in FIG. 7.

### DETAILED DESCRIPTION OF THE INVENTION

### First Embodiment

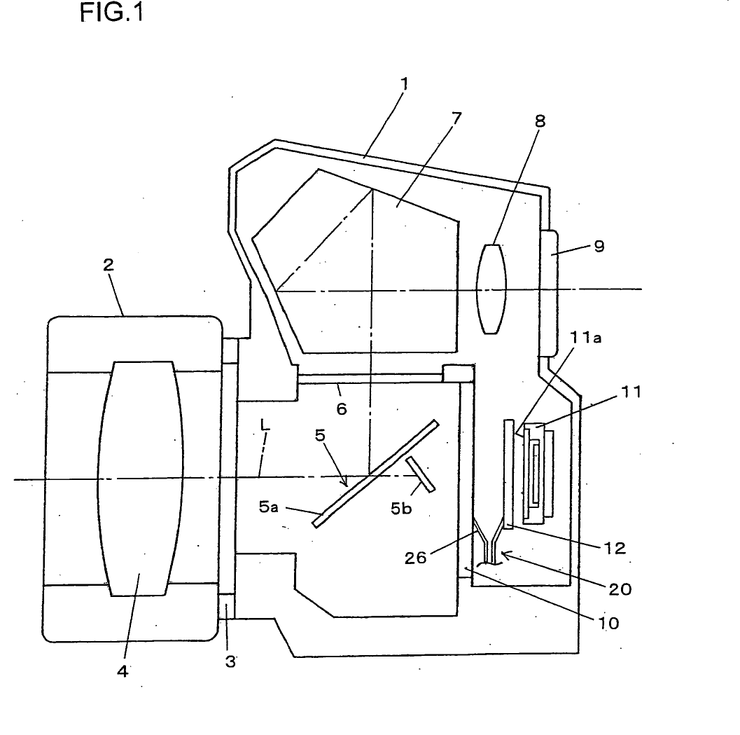

Referring to FIGS. 1 to 6, a digital camera according to a first embodiment of the present invention is explained.

FIG. 1 is a cross-sectional view schematically showing a configuration in whole of a digital camera according to a first embodiment of the present invention. The digital camera of the present embodiment is a single-lens reflex digital camera of an interchangeable lens type, which includes a camera body 1 and an interchangeable lens 2 that is interchangeably attached to the camera body 1 through a lens mount 3. The digital camera also includes a photographic lens 4 through which light L from a photographic subject passes to a quick return mirror 5 including a main mirror 5a and a submirror 5b arranged on a rear side of the main mirror 5a. On the main mirror 5a, the light from the photographic subject that has passed through the photographic lens 4 is split into two light fluxes, that is, a reflection light flux, which is reflected on the main mirror 5a to be guided to a viewfinder optical system and a transmission light flux, which is transmitted through the main mirror 5a and reflected on the submirror 5b. The reflected light flux is used as a light flux for autofocusing (AF).

The light flux reflected on the main mirror 5a forms an image on a finder screen 6 provided in the camera body 1. The image on the finder screen 6 can be observed through a pentaprism 7, an eyepiece 8, and an ocular viewfinder window 9. These elements are arranged in an optical light path in the viewfinder optical system. Upon photographing, the quick return mirror 5 is sprung out or otherwise quickly placed outside the optical light path and a shutter unit 10, which covers an image sensor 11 placed in the camera body 1 at an end of a photographic light path, is opened to allow an image of the photographic subject to be formed on an imaging surface of the image sensor 11.

When photographing is not performed, the quick return mirror 5 is placed on the optical light path as shown in FIG. 1 and the shutter 10 is set in a closed state. Note that in the following explanation, the space in the camera body 1 is divided into two regions with the shutter unit 10 serving as a boundary therebetween. One of them, which is located on the side of the image sensor 11 (right hand side in FIG. 1), is referred to as an image sensor accommodating space and the other, which is located on the side of the quick return mirror 5 (left hand side in FIG. 1), is referred to as a mirror box.

The image sensor 11 is provided with a cover glass 11a to protect an imaging section 11b of the image sensor 11. The image sensor 11 may be a CCD (charge-coupled device) image sensor. Also, an image sensor other than the CCD image sensor, for example, a CMOS (complementary metal-oxide semiconductor) image sensor can be used. Anteriorly near the image sensor 11, there is provided an optical low pass filter 12. Between the shutter unit 10 and the optical low pass filter 12 is provided a dust removing unit 20 for removing dust floating in the image sensor accommodating space. Hereinafter, explanation is made on the construction of the dust removing unit 20.

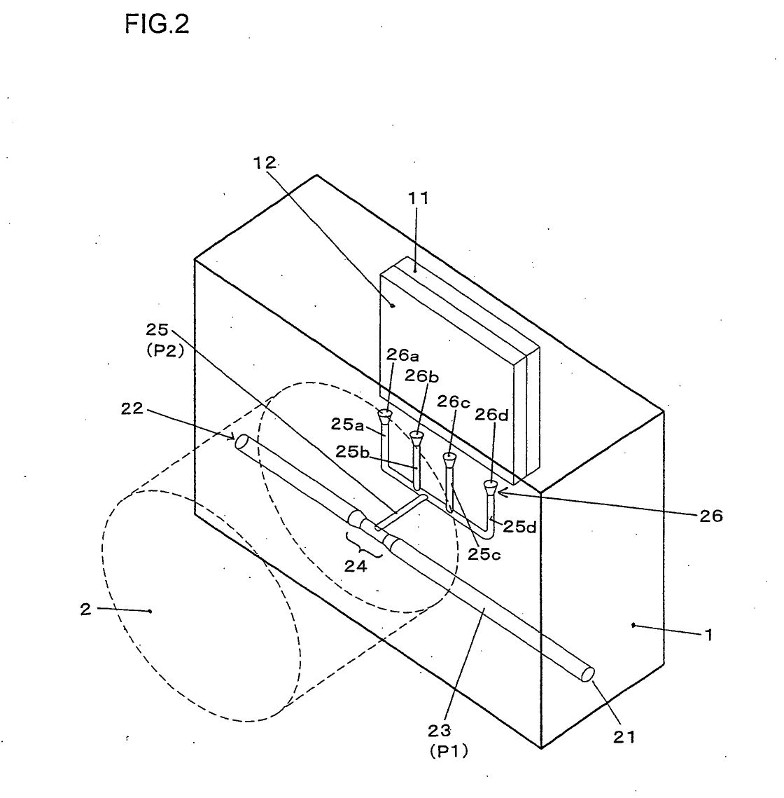

FIG. 2 is a perspective view showing a construction of the dust removal unit 20. The camera body 1 is provided with an air inlet port 21 on one side thereof and an air outlet port 22 on the other side thereof. A passage forming member 23 extends in the camera body 1 so as to communicate with the air inlet port 21 and the air outlet port 22. The passage forming member 23 defines therein an air passage P1. The passage forming member 23 is provided with a restricted section 24 with a reduced cross-section of the passage, to which a passage forming member 25 is connected on one end thereof substantially at right angles. The passage forming member 25 is provided on the other end thereof with a suction unit 26.

The passage forming member 25 is forked into a plurality of passage forming members, for example, four passage forming members 25a to 25d. The suction unit 26 includes a plurality of suction ports, for example, four suction ports 26a to 26d, correspondingly. The passage forming members 25a to 25d are provided on respective ends thereof with suction ports 26a to 26d, each of which faces and is open in the image sensor accommodating space. The passage forming member 25 and the suction unit 26 constitute the air passage P2, which extends from the restricted section toward the image sensor accommodating space. The passage forming members 23 and 25 may be made of, for example, air tubes. Note that each unit arranged in the camera body 1 may be provided with a through hole to form the first and the air passages P1 and P2. In this case, each member that is provided with a through hole constitutes the air forming member 23 or 25.

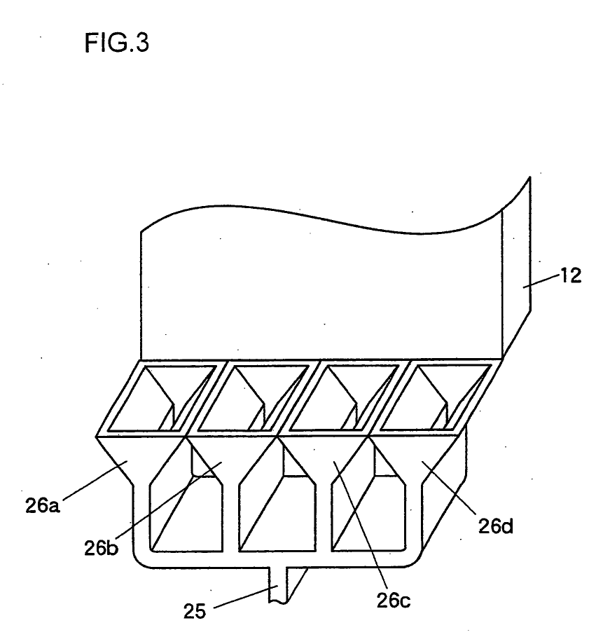

Each of the suction ports 26a to 26d in the suction unit 26 is in the form of a funnel having an opening area increasing upward. Further, as shown in FIG. 1, the open end of each of the suction ports 26a to 26d is arranged near the shutter unit 10 and the low pass filter 12. Note that in the construction shown in FIG. 2, the suction ports 26a to 26d are arranged separately from each other. However, they may be arranged in a different manner. For example, as shown in FIG. 3, the suction ports 26a to 26d each having a rectangular or square opening may be arranged close to each other side by side such that a bottom area of the space between the shutter unit 10 and the low pass filter 12 can be covered thereby entirely. Also, the suction ports 26a to 26d may be integrated to eliminate gaps between the adjacent suction ports 26a to 26d.

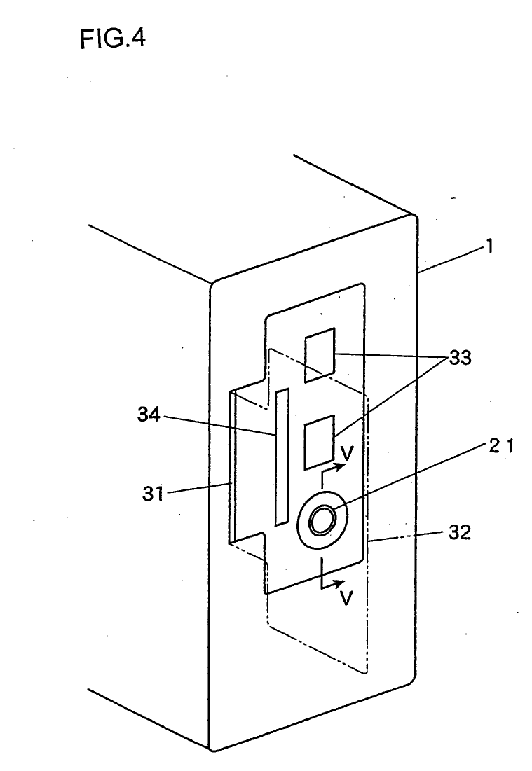

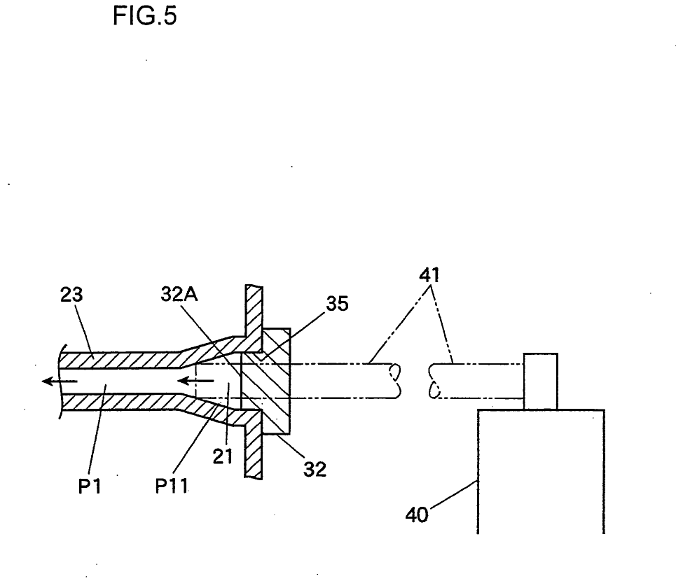

FIG. 4 is a perspective view showing a construction of a side portion of a camera body of the digital camera according to the first embodiment. FIG. 5 is a cross-sectional view of the camera body in FIG. 4 along the V-V line. As shown in FIG. 4, a cover 32 made of a flexible material, such as rubber, is rotatably attached to a side surface of the camera body 1 through a hinge 31 provided parallel to an edge of the side surface of the camera body 1. In an area of the side surface of the body camera 1 to be covered by the cover 32 when the cover 32 is in a closed state, there are provided terminals 33 for connecting cables for inputting/outputting various signals from/to external apparatus, a loading slot 34 for loading or inserting a memory card, and the air inlet port 21.

As shown in FIG. 5, a counterbore section 35 is provided around the air inlet port 21 and a protrusion 32A is provided on an inner surface of the cover 32 corresponding to the counterbore 35. When the cover 32 is in a closed state, the protrusion 32A of the cover 32 fits the counterbore 35 to close the air inlet port 21 airtightly. This prevents dust from coming into the air passage P1 from outside. Note that on the opposite side of the camera body 1, there is attached the cover 32 made of rubber in a similar manner. In an area of the side surface of the opposite side of the body camera 1 to be covered by the cover 32 when the cover 32 is in a closed position, there is arranged the air outlet port 22. A cap that covers the air inlet port 21 and the air outlet port 22 may be provided separately from the cover 32.

The air passage P1 is tapered in the vicinity of the air inlet port 21 and the cross-section area of the passage decreases gradually in the tapered portion P11. For this reason, when the cover 32 is removed from the air inlet port 21 and a nozzle 41 of an air spray 40 is inserted into the air inlet port 21 as indicated by a dashed two-dotted line in FIG. 5, a leading end of the nozzle 41 abuts the tapered portion P11 to enable high-pressure air to be sprayed toward the air outlet port 22.

Now, explanation is made on operation characteristic to the camera according to the present embodiment. Upon removal of dust in the inside of the camera, first the covers 32 are removed from the air inlet port 21 and the air outlet port 22, i.e., the covers 32 are turned around the hinges 31 to uncover the air inlet port 21 and the air outlet port 22, respectively. Then, as shown in FIG. 5, the nozzle 41 of the air spray 40 is inserted into the air inlet port 21 and the air spray 40 is operated to spray air into the air passage P1. The air spray 40 that can be used is, for example, a commercially available spray of a can type in which high-pressure air is filled. The can type spray may be one that contains a gas other than air.

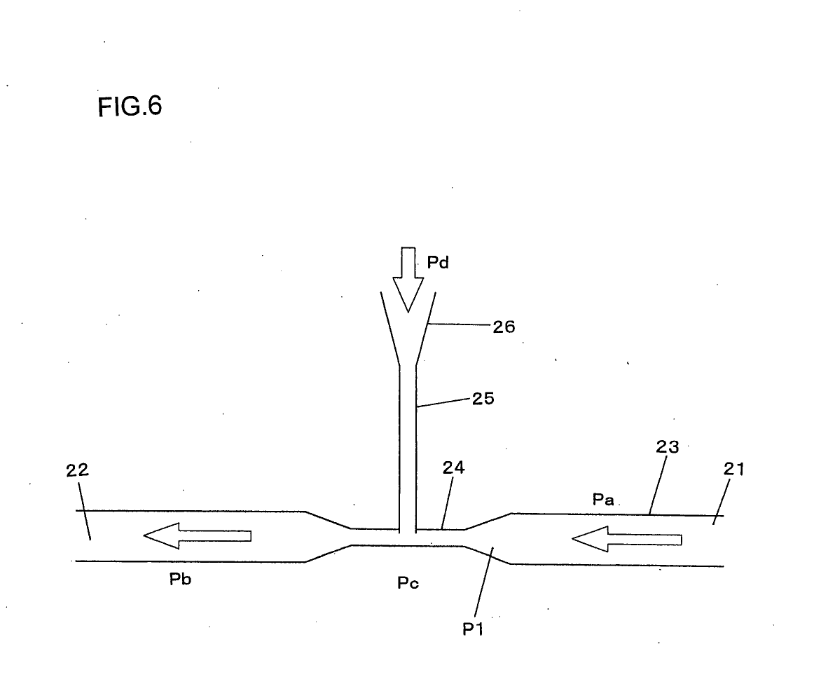

Referring to FIG. 6, explanation is made on the flow of air when air is injected into the air passage P1 from the air spray 40 (FIG. 5). It is assumed that Pa indicates a pressure of a portion of the air passage P1 upstream of the restricted section 24, Pb indicates a pressure of a portion of the air passage P1 downstream of the restricted section 24, Pc indicates a pressure of the restricted section 24, and Pd indicates a pressure in the image sensor accommodating space facing the suction unit 26. Then, the air injected into the air passage Pl passes the restricted section 24 where the cross-section area of the passage is restricted to increase flow rate of the gas. As a result, the pressure (static pressure) in the restricted section 24 is decreased to a negative pressure and the relationship between the pressures Pa, Pb, and Pc in the passage P1 is Pc<Pb<Pa.

In this case, since the pressure in the image sensor accommodating space is the pressure of the atmosphere, there is established a relationship among the pressures Pa, Pc, and Pd of Pc<Pd<Pa. Accordingly, the dust in the image sensor accommodating space is sucked into the air passage P1 through the suction unit 26 and is conveyed along the flow of air to be discharged from the air outlet port 22. This enables the dust in the image sensor accommodating space to be efficiently removed, so that a decrease in quality of photographic image due to catching by the camera, i.e., appearance of the dust in a photograph can be prevented.

According to the first embodiment of the present invention, the following advantages can be obtained.

(1) The air passage P1 is formed in the camera body extending from the air inlet port 21 to the air outlet port 22 and the air passage P2 is formed as branched from the restricted section 24 of the air passage P1 toward the image sensor accommodating space defined between the shutter unit 10 and the low pass filter 12. This construction enables a negative pressure to be generated in the restricted section 24 when high-pressure air is injected into the air passage P1 from the air inlet port 21, allowing the dust in the image sensor accommodating space to be sucked into the air passage P1 through the air passage P2 to sufficiently remove the dust floating in the image sensor accommodating space.

(2) Since the dust is removed by suction force generated by the injection of air and he construction of the dust removing unit can be made simpler, the dust in the image sensor accommodating space can be discharged from the camera to the outside by a low cost construction. Further, it is unnecessary to detach the interchangeable lens when the dust removal operation is performed. The dust removal operation can be easily performed even outdoors if only a commercial air spray is available.

(3) The air passage P2 branching from the restricted section 24 is branched into a plurality of passages communicating with a plurality of suction ports 26a to 26d facing the image sensor accommodating space. This makes the area of the suction unit 26 larger to enable the dust in the image sensor accommodating space to be sucked easily.

(4) Since the air inlet port 21 and the air outlet port 22 are airtightly covered by the cover 32, the dust can be prevented from entering the camera body from outside. Further, since the air inlet port 21 and the air outlet port 22 are also covered by the cover 32 for covering the connection terminals 33 and loading slot 34 for loading a memory card, an increase in number of parts can be prevented.

(5) The air passage P1 on the side of the air inlet port 21 is tapered. This construction enables injection of air such that the leading edge of the nozzle 41 of the air spray 40 abuts the inner periphery of the air passage P1. As a result, leakage of sprayed air is decreased to make the flow rate of the air in the restricted section 24 greater, resulting in an increased suction force for sucking the dust.

### Second Embodiment

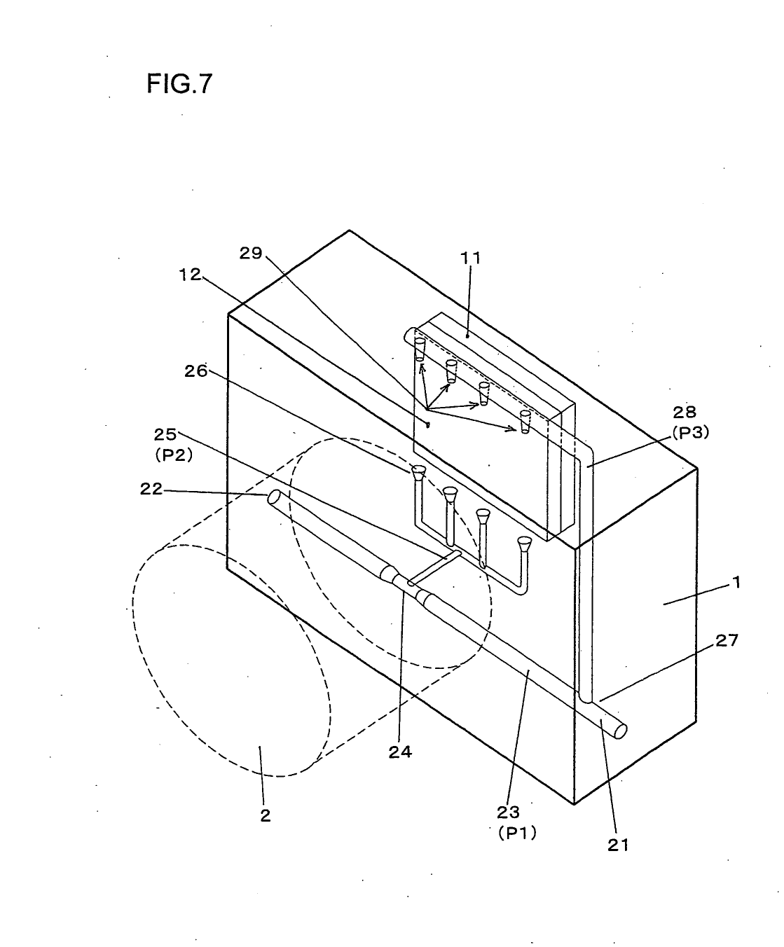

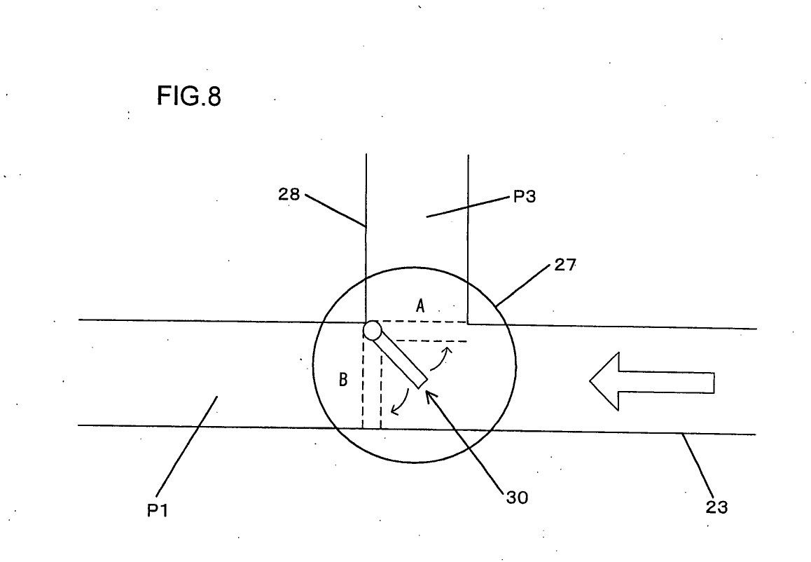

Referring to FIGS. 7 and 8, explanation is made on a camera according to a second embodiment of the present invention.

In the first embodiment, the dust in the image sensor accommodating space is sucked into the air passage P1 through the air passage P2. In contrast, in the second embodiment, the dust removal system is configured such that air is further sprayed toward the front surface of the low pass filter 12 to remove the dust that adheres thereto. Note that hereinafter, explanation is focused on differences of the second embodiment from the first embodiment.

FIG. 7 is a perspective view showing a construction of the dust removal unit of the digital camera according to the second embodiment. Note that the same parts or components are indicated by the same reference numerals. The passage-forming member 23 has a branch section 27, downstream of the tapered portion P11 (FIG. 5) and upstream of the restricted section 24, from which a passage-forming member 28 branches. The passage-forming member 28 extends to an upper area of the image sensor accommodating space to form an air passage P3. At an end of the passage-forming member 28, there are provided a plurality of spray nozzles 29 for spraying the spray gas directed downward or obliquely downward toward the surface of the low pass filter 12.

In the second embodiment, when high-pressure air is injected into the air passage P1 by an air spray, a portion of the high-pressure air flows into the air passage P3 through the branch section 27 and is sprayed from the spray nozzles 29 toward the front surface of the low pass filter 12. Due to force of the blown air the dust that has adhered to the front surface of the low pass filter 12 is removed and the removed dust is blown off toward the underlying suction unit 26. On the other hand, the remainder of high-pressure air injected into the air passage P1 does not pass through the air passage P3 but through the restricted section 24, so that the restricted section comes to be at a negative pressure, i.e., under atmospheric pressure. This generates suction force to suck the air containing the dust from the image sensor accommodating space to the suction port 26, so that the dust removed by the force of the blown air is sucked into the air passage P1 and conveyed as entrained in the air flow therein to be discharged to the outside through the air outlet port 22.

In the second embodiment as described above, the air passage P3 is provided between the air passage P1 upstream of the restricted section 24 and the air sprayed from the air inlet port 21 is sprayed onto the front surface of the low pass filter 12 through the air passage P3. With this construction, the dust that has adhered to the low pass filter 12 can be blown off, so that not only the dust that already floats in the image sensor accommodating space but also the dust that still adheres to the low pass filter 12 can be removed.

It would be also acceptable to provide a valve mechanism 30 in the branch portion 27 of the air passage P3 so that distributions of flow rates of the air that passes the air passage P3 and of the air that does not pass the air passage P3 can be varied by operation of the valve mechanism 30. With this construction, blowing of air onto the front surface of the low pass filter 12 and suction of air into the suction unit 26 can be balanced optimally. Further, it would be acceptable to operate the valve mechanism 30 to be set at a position B in FIG. 8 to allow the total amount of the high-pressure air to flow into the air passage P3 to blow off the dust that has adhered to the low pass filter 12 and then operate the valve mechanism 30 to be set at a position A in FIG. 8 to perform suction of the dust. In this case, the valve mechanism 30 may be configured to be automatically driven. Note that the specific construction of the valve mechanism as a unit for varying the flow rate distribution may be of any type. For example, a dial interlocked to the valve mechanism 30 may be provided on the surface of the camera body 1 to enable the valve mechanism 30 to be driven by operation of the dial.

In the second embodiment, the air passage P3 (second passage) is constituted by the passage-forming member 28. However, instead of providing the air passage P3 by branching it from the air passage P1, it would be also acceptable to provide the air passage P3 of a separate system from that of the air passage P1. In this case, an air inlet port that communicates with the air passage P3 is provided to inject air into the air passage P3 from the air inlet port. Although air is blown onto the front surface of the low pass filter 12, if there is an object having a surface to which dust adheres, air may be blown onto the surface of the object in a similar manner.

In the first embodiment, when air is injected into the air inlet port 21 with the cover 32 being in a closed state to shut the air outlet port 22, the air flows out from each of the suction ports 26a to 26d through the air passage P2. This enables the dust which has adhered to the low pass filter 12 to be blown off. Thereafter, the blown off dust is sucked into the air passage P1 and discharged from the air outlet port 22 when high-pressure air is injected into the air passage P1 and with the cover 32 being in a removed state to open the air outlet port 22.

Note that in the above-mentioned embodiments, the air inlet port 21 and the air outlet port 22 are provided on the opposite sides, respectively, of the camera body 1. However, the positions of the air inlet port and the air outlet port are not limited thereto. For example, the air inlet port 21 and the air outlet port 22 may be provided on the same surface of the camera body 1. Accordingly, the shape of the passage-forming member 23 that constitutes the air passage P1 (first passage) is not limited to the above-mentioned shape. In the above-mentioned embodiments, the restricted section 24 and the image sensor accommodating space are communicated via the passage-forming member 25. However, if the restricted section 24 can be arranged near the image sensor accommodating space, the passage-forming member 25 may be omitted.

The restricted section 24 is communicated with the image sensor accommodating space between the low pass filter 12 as an optical member and a shutter unit 10 placed in the front thereof. However, if there is any other space in the photographic light path in which dust is floating, the restricted section 24 may be communicated with that space. The construction of the communication unit is not limited to the above-mentioned one. While a plurality of flows from a plurality of suction ports 26a to 26d are united through the passage-forming member 25, the construction of the confluent passage P2 is not limited to the above-mentioned one. The present invention is applicable not only to a single-lens reflex digital camera but also to other digital cameras having an image sensor. That is, the present invention is not limited to the digital cameras according to the embodiments as far as the features and functions are realized.

The above-mentioned embodiment and various variations are exemplary and the present invention should not be construed as being limited thereto and the invention may be modified in various manners unless the features of the present invention are damaged.

What is claimed is:

1. A digital camera comprising:
a camera body provided with an inlet port and an outlet port for a spray gas, the camera body defining a space in a photographic light path;
a first passage formed in the camera body to communicate the inlet port and the outlet port, the first passage being provided with a restricted section; and
a communication unit that communicates the restricted section of the first passage with the space in the photographic light path in the camera body, wherein
when the spray gas flows through the first passage, dust floating in the space in the photographic light path is led to the restricted section by flow of the spray gas.

2. A digital camera according to claim 1, further comprising:
an image sensor having a front surface on which an image of a photographic subject is incident via the photographic light path;
an optical member arranged near the front surface of the image sensor; and
a shutter unit arranged in front of the optical member in the photographic light path, wherein
the space in the photographic light path is a space between the optical member and the shutter unit.

3. A digital camera according to claim 1, further comprising:
a second passage branching from the first passage upstream of the restricted section, wherein
the second passage is configured to lead the spray gas that flows in through the inlet port for the spray gas toward a surface of an object to which dust adheres in the photographic light path.

4. A digital camera according to claim 3, further comprising:
a flow rate distribution varying unit that varies flow rate distribution between a flow rate of the spray gas that passes through the second passage and a flow rate of the spray gas that does not pass through the second passage and flows toward the outlet port.

5. A digital camera according to claim 1, wherein:
the communication unit includes
a suction unit provided facing the space in the photographic light path; and
a passage guiding a flow from the suction unit to the restricted section.

6. A digital camera according to claim 5, wherein:
the suction unit includes a plurality of suction ports, and
the passage guiding a flow from the suction unit to the restricted section includes a confluent passage that unites flows from the plurality of suction ports and guides the united flow to the restricted section.

7. A digital camera according to claim 6, wherein:
the plurality of suction ports has each a rectangular opening and are arranged adjacent to each other.

8. A digital camera according to claim 7, further comprising:
an image sensor having a front surface on which an image of a photographic subject is incident via the photographic light path;
an optical member arranged near the front surface of the image sensor; and
a shutter unit arranged in front of the optical member, wherein
the plurality of suction ports are arranged so as to cover a predetermined area of a plane parallel to a bottom surface of a space between the optical member and the shutter unit.

9. A digital camera according to claim 6, wherein:
each of the plurality of suction ports is in the form of a funnel.

10. A digital camera according to claim 6, wherein:
the plurality of suction ports are arranged separate one from another.

11. A digital camera according to claim 3, wherein:
the second passage is provided with a plurality of spray nozzles that sprays the spray gas.

12. A digital camera according to claim 4, wherein:
the flow rate distribution unit includes a valve mechanism.

13. A digital camera according to claim 4, further comprising:
a drive unit that drives the flow rate distribution unit.

14. A digital camera according to claim 1, further comprising:
a protective member capable of sealing the inlet port for the spray gas.

15. A digital camera according to claim 14, wherein:
the protective member is provided through a hinge on a side of the camera body where the inlet port is provided.

16. A digital camera according to claim 14, wherein:
the protective member has a concave section on its inner side,
a counterbore section capable of engaging with the concave section of the protective member is proved around the inlet port for the spray gas, and
the protective member is rotatable to a close position at which the inlet port for the spray gas is sealed.

17. A digital camera according to claim 1, wherein:
the inlet port for the spray gas is provided with a tapered section having an increased diameter outward, and
the tapered section is capable of receiving a spray gas injection device that injects the spray gas into the first passage.

18. A digital camera comprising:
a camera body provided with an inlet port and an outlet port for a spray gas, the camera body defining a space including a photographic light path therein;
an image sensor provided in the camera body which receives an image of a photographic subject through the photographic light path;
an optical member provided in front of the imaging sensor in the photographic light path;
a shutter unit arranged in front of the optical member in the photographic light path; and
a dust removing unit provided in the camera body that removes dust mixed in or generated in the camera body, wherein
the dust removing unit includes
a first passage formed in the camera body to communicate the inlet port and the outlet port, the first passage being provided with a restricted section having a reduced cross-section;
a second passage branching from the first passage upstream of the restricted section, configured to lead the spray gas that flows in through the inlet port for the spray gas toward a surface of an object to which dust adheres in the photographic light path;
a flow rate distribution varying unit that is provided on a position where the second passage branches from the first passage and is adapted to vary flow rate distribution between a flow rate of the spray gas that passes through the second passage and a flow rate of the spray gas that does not pass through the second passage and flows to the outlet port; and
a communication unit that communicates the restricted section of the first passage with the space in the photographic light path in the camera body, wherein
when the spray gas injected from the inlet port flows through the first passage and the second passage, the dust on the surface of the object comes off from the surface of the object due to flow of the spray gas from the second passage and dust floating in the space in the photographic light path containing the dust coming off from the surface of the object is led to the restricted section of the first passage through the communication unit due to a negative pressure generated in the restricted section and is discharged from the outlet port due to flow of the spray gas that passes through the first passage toward the outlet port via the restricted section.
